(19) United States
(12) Patent Application Publication
(10) Pub. No.: US 2025/0348303 A1
(43) Pub. Date: Nov. 13, 2025

(54) ARTIFICIAL INTELLIGENCE-BASED SERVER FIRMWARE UPGRADES IN TELECOMMUNICATION CLUSTERS

(71) Applicant: Dell Products L.P., Round Rock, TX (US)

(72) Inventors: Mihai Lazar, Nepean (CA); Ramesh Ganapathi, Chennai (IN); Vinay Sawal, Fremont, CA (US); Priyatham Khaspa, Bangalore (IN)

(21) Appl. No.: 18/660,910

(22) Filed: May 10, 2024

(51) Int. Cl. G06F 8/65

(52) U.S. Cl. CPC G06F 8/65

(57) ABSTRACT

A method facilitating artificial intelligence-based server firmware upgrades in telecommunication clusters includes adjusting, by a first system including at least one processor, parameters of a central machine learning model based on parameter data received from a second system that is not the first system, the parameter data being generated by a local machine learning model that is local to the second system; and, in response to the adjusting, generating, by the first system, a schedule for a firmware upgrade to be applied to at least one device of a third system that is not the first system, the generating of the schedule including applying the central machine learning model to system deployment data associated with the third system and upgrade data associated with the firmware upgrade.

### BACKGROUND

Current telecommunications system deployments, such as those utilizing Fifth Generation (5G) wireless standards, can make extensive use of computing servers for executing containerized workloads. For instance, a gNodeB (gNB), which serves as a base station in 5G, can use multiple servers and/or server clusters to realize centralized unit (CU) and/or distributed unit (DU) functionality. Other elements of a wireless communication network, such as at the core network and/or radio access network levels, can also use servers and/or server clusters to implement their respective functionality. A typical telecommunications deployment can include thousands of servers, deployed at various locations (e.g., data centers, cell sites, etc.), and these locations can be interconnected through network links of various characteristics (throughput, latency, reliability, etc.).

### SUMMARY

The following summary is a general overview of various embodiments disclosed herein and is not intended to be exhaustive or limiting upon the disclosed embodiments. Embodiments are better understood upon consideration of the detailed description below in conjunction with the accompanying drawings and claims.

In an implementation, a system is described herein. The system can include at least one processor and at least one memory that stores executable instructions that, when executed by the at least one processor, facilitate performance of operations. The operations can include adjusting parameters of a first machine learning (ML) model based on model parameter data representative of at least one model parameter usable to configure at least one model, the model parameter data having been received from a first telecommunications system deployment, and the model parameter data having been generated by a second ML model maintained by the first telecommunications system deployment. The operations can further include, in response to the adjusting, generating a firmware upgrade schedule for a second telecommunications system deployment by applying the first ML model to deployment data associated with the second telecommunications system deployment and upgrade data associated with a firmware upgrade to be applied to at least one device of the second telecommunications system deployment.

In another implementation, a method is described herein. The method can include adjusting, by a first system including at least one processor, parameters of a central ML model based on parameter data received from a second system that is not the first system, the parameter data being generated by a local ML model that is local to the second system. The method can further include, in response to the adjusting, generating, by the first system, a schedule for a firmware upgrade to be applied to at least one device of a third system that is not the first system, the generating of the schedule including applying the central ML model to system deployment data associated with the third system and upgrade data associated with the firmware upgrade.

In an additional implementation, a non-transitory machine-readable medium is described herein that can include instructions that, when executed by at least one processor, facilitate performance of operations. The operations can include refining parameters of a first ML model based on model parameter data received from a first telecommunications system, the model parameter data being generated by a second ML model maintained by the first telecommunications system; and in response to the refining, generating a firmware upgrade schedule for a second telecommunications system, the generating including applying the first ML model to system data associated with the second telecommunications system and upgrade data associated with a firmware upgrade to be applied to at least one device of the second telecommunications system.

### DESCRIPTION OF DRAWINGS

Various non-limiting embodiments of the subject disclosure are described with reference to the following figures, wherein like reference numerals refer to like parts throughout unless otherwise specified.

FIG. 1 is a block diagram of a system that facilitates artificial intelligence (AI)-based server firmware upgrades in telecommunication clusters in accordance with various implementations described herein.

FIG. 2 is a diagram of an example communication network architecture on which various implementations described herein can function.

FIGS. 3-4 are diagrams depicting respective aspects of an example federated learning (FL) framework that can be used to facilitate AI-based server firmware upgrades in telecommunication clusters in accordance with various implementations described herein.

FIGS. 5-6 are block diagrams of additional systems that facilitate AI-based server firmware upgrades in telecommunication clusters in accordance with various implementations described herein.

FIG. 7 is a diagram illustrating example firmware upgrade operations that can be performed on the network architecture of FIG. 2.

FIGS. 8-9 are diagrams illustrating an example process for selecting a backup server for a firmware upgrade operation in accordance with various implementations described herein.

FIGS. 10-11 are flow diagrams of methods that facilitate AI-based server firmware upgrades in telecommunication clusters in accordance with various implementations described herein.

FIGS. 12-13 are diagrams of respective example computing environments in which various implementations described herein can function.

### DETAILED DESCRIPTION

Various specific details of the disclosed embodiments are provided in the description below. One skilled in the art will recognize, however, that the techniques described herein can in some cases be practiced without one or more of the specific details, or with other methods, components, materials, etc. In other instances, well-known structures, materials, or operations are not shown or described in detail to avoid obscuring subject matter.

As noted above, current telecommunications system deployments can make extensive use of computing servers for data processing. For instance, new Fifth Generation (5G) standards deployments, both for the 5G core network and radio access network (RAN), can make use of off-the-shell computing servers for executing 5G workloads, e.g., in Kubernetes clusters. As additionally noted above, a typical telecommunications deployment can include thousands of interconnected servers. These servers can be characterized by their hardware attributes (e.g., compute power/central processing unit (CPU) specifications, memory size, storage size, network bandwidth, etc.) and the software executed by the servers. This software can include, e.g., basic input/output system (BIOS), device drivers and/or firmware for storage, network interface cards, or other devices, a runtime platform (e.g., including an operating system (OS), Kubernetes, etc.), 5G software applications and/or other applications, or other suitable software components.

When deploying new software or upgrading software associated with a telecommunications deployment, a communication provider generally uses a continuous integration/continuous delivery (CI/CD) pipeline to perform the initial deployment, testing, and upgrades of the production environment. During these processes, it is desirable to maintain a minimum level of service associated with the underlying communication network, e.g., such that service level agreement (SLA) parameters are not affected. However, in many cases, a telecommunication deployment involves a heterogeneous set of servers with different hardware and software characteristics, in which software and/or firmware components can be provided by many different vendors. Additionally, application software vendors can perform their own validation on a given software lineup.

Various implementations described herein can address shortcomings of present techniques for performing upgrades for large telecommunications deployments. For instance, if performed manually or even (semi-) automatically with the use of conventional scripts, lifecycle firmware management for all servers in a large 5G telecommunications deployment can be a very complex process that is error-prone, time-consuming, and insufficient for the needs of a CI/CD pipeline. This can be due to the fact that 5G deployments can be very large (e.g., on the order of thousands of servers), such that it is not possible to upgrade all of them in a single maintenance window. Additionally, firmware updates for server clusters across different time zones can require a large amount of pre-planning and lab work, and downtime and maintenance window planning for multiple sites associated with a 5G or other telecommunications deployment can depend on many factors and be very complex. Multiple downtime windows are often needed, as firmware upgrades are generally manual or semi-automated and this process is not conventionally scalable. Further, to avoid service interruptions, workloads from servers to be upgraded must generally be migrated to other available servers, and this migration is time consuming and increases the probability of failure and network congestion. Additionally, all servers should desirably run the same version of any relevant firmware components to avoid any performance issues and/or inconsistencies, as different firmware versions can in some cases present compatibility issues with each other.

Implementations as described herein can further the above and/or related ends by facilitating a fully automated server firmware upgrade process for the servers of a telecommunications deployment, such as a 5G deployment, that enables a CI/CD approach. This process can utilize a federated learning (FL) approach to train a global upgrade model with data from multiple deployment, including deployments of different communications providers. By implementing automated upgrade processes as described herein, various advantages can be achieved that can improve the performance of a computing system, such as that associated with a telecommunications deployment. These advantages can include, but are not limited to, the following. Firmware upgrades for large deployments, e.g., on the order of thousands of devices, can be organized, scheduled and executed in an automated manner, thereby reducing or eliminating human error from the process. Additionally, firmware upgrades can be performed as described herein in less time than that associated with conventional deployments, resulting in fewer required maintenance windows and improved device performance. Impact to system performance, e.g., with reference to an SLA or other defined baseline performance level, can be reduced as compared to manual firmware upgrade. Other advantages are also possible.

It is noted that while various examples provided herein relate to 5G deployments, these examples are provided merely for illustrative purposes and are not intended to limit the description or the claimed subject matter to any particular network standard(s) or technology (-ies) unless explicitly stated otherwise. Additionally, while various examples herein relate specifically to upgrading firmware (e.g., BIOS, device drivers, etc.), it is noted that respective implementations herein could also be extended to performing other upgrades, such as upgrades of software (e.g., operating systems, applications, etc.) running on respective computing devices, without departing from the scope of this description. It is also noted that, due to the nature and quantity of data that can be processed by machine learning (ML) models as described herein, as well as the manner in which such data is processed, implementations described herein can facilitate operations that could not be performed in the human mind, or by a general-purpose computer utilizing conventional computing techniques, in a useful or reasonable timeframe.

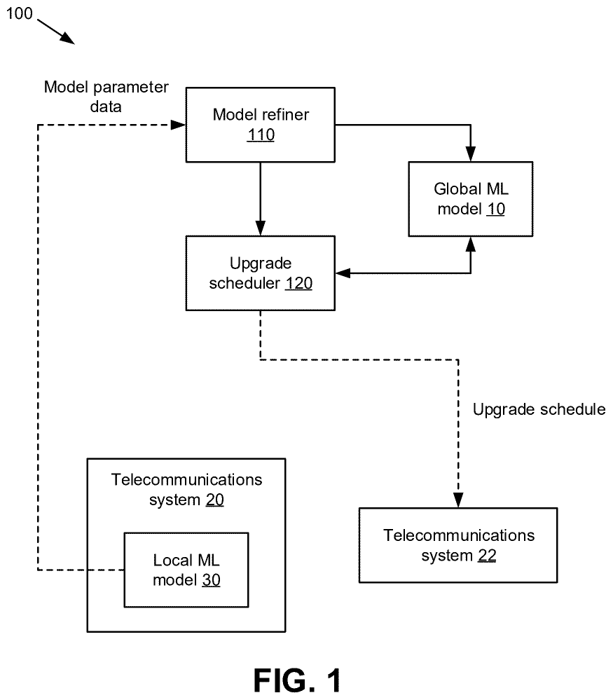

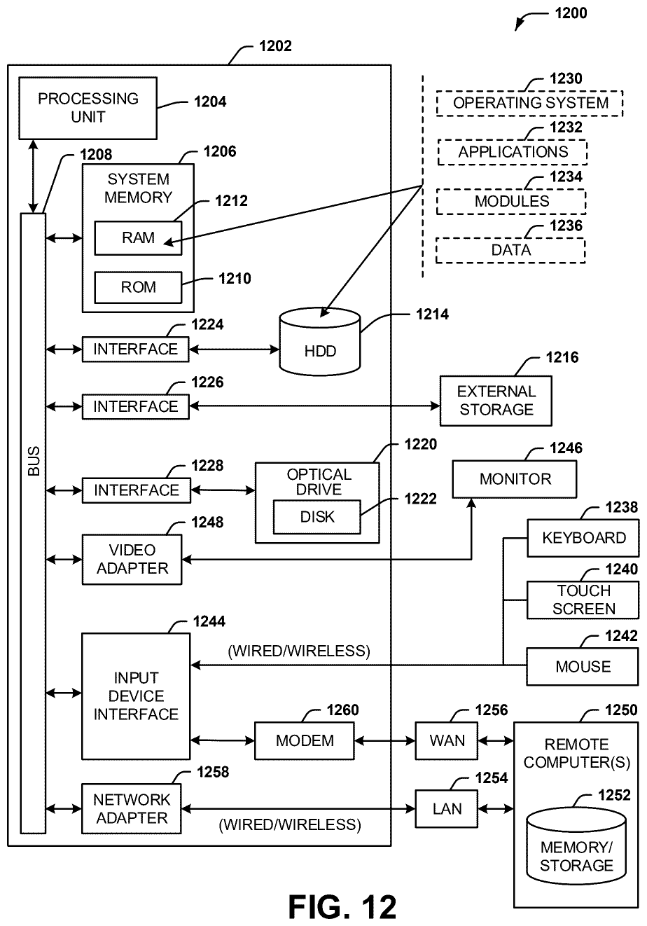

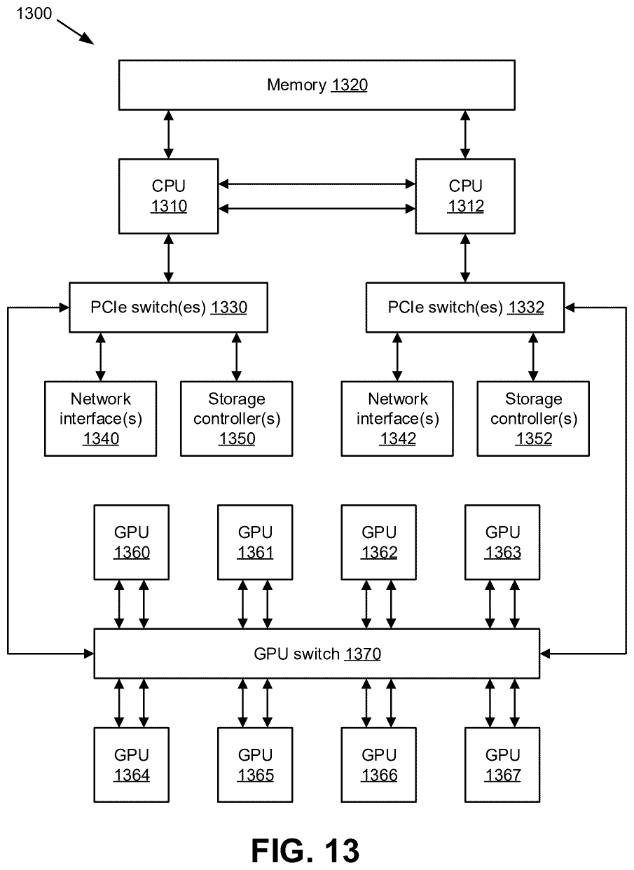

With reference now to the drawings, FIG. 1 illustrates a block diagram of a system 100 that facilitates AI-based server firmware upgrades in telecommunication clusters in accordance with various implementations described herein. System 100 as shown in FIG. 1 includes executable components, e.g., a model refiner 110 and an upgrade scheduler 120, each of which can operate as described in further detail below. In an implementation, the components 110, 120 of system 100 can be implemented in hardware, software, or a combination of hardware and software. By way of example, the components 110, 120 can be stored on at least one memory and executed by at least one processor. Examples of computer architectures including processors and memories that can be used to implement the components 110, 120, as well as other components as will be described herein, are shown and described in further detail below with respect to FIGS. 12-13.

Additionally, it is noted that the functionality of the respective components shown and described herein can be implemented via a single computing device and/or a combination of devices. For instance, in various implementations, the model refiner 110 shown in FIG. 1 could be implemented via a first device, and the upgrade scheduler 120 could be implemented via the first device or a second device. Also, or alternatively, the functionality of a single component could be divided among multiple devices in some implementations.

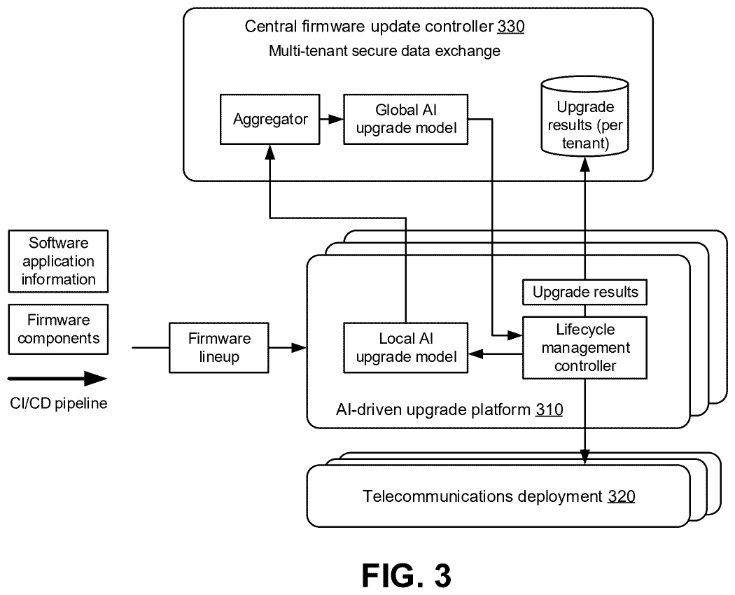

With reference now to the components of system 100, the model refiner 110 can adjust parameters of a first ML model, e.g., a global ML model 10 as shown in FIG. 1, based on model parameter data that is representative of at least one model parameter usable to configure at least one model, e.g., at least one local ML model 30 as additionally shown in FIG. 1. As shown in FIG. 1, the model parameter data can be received from a first telecommunications system deployment, e.g., associated with a first telecommunications system 20. The model parameter data, in turn, can be generated by a second ML model, e.g., the local ML model 30, that is maintained by the first telecommunications system 20. Further details regarding the interactions between the global ML model 10 and the local ML model 30 shown in FIG. 1 are described below with regard to FIG. 3.

In response to the model refiner 110 adjusting the parameters of the first ML model, the upgrade scheduler 120 of system 100 can generate a firmware upgrade schedule for a second telecommunications system deployment, e.g., associated with a second telecommunications system 22, by applying the first ML model to deployment data associated with the second telecommunications system deployment as well as upgrade data associated with a firmware upgrade to be applied to at least one device of the second telecommunications system deployment.

While the first and second telecommunications system deployments are shown in FIG. 1 as being associated with separate telecommunications systems 20, 22, it is noted that these deployments could also be associated with the same system. For example, the telecommunications system 20 could provide model parameter data to the model refiner 110 based on its local ML model 30, based on which the upgrade scheduler 120 could generate an upgrade schedule for devices of the same telecommunications system 20.

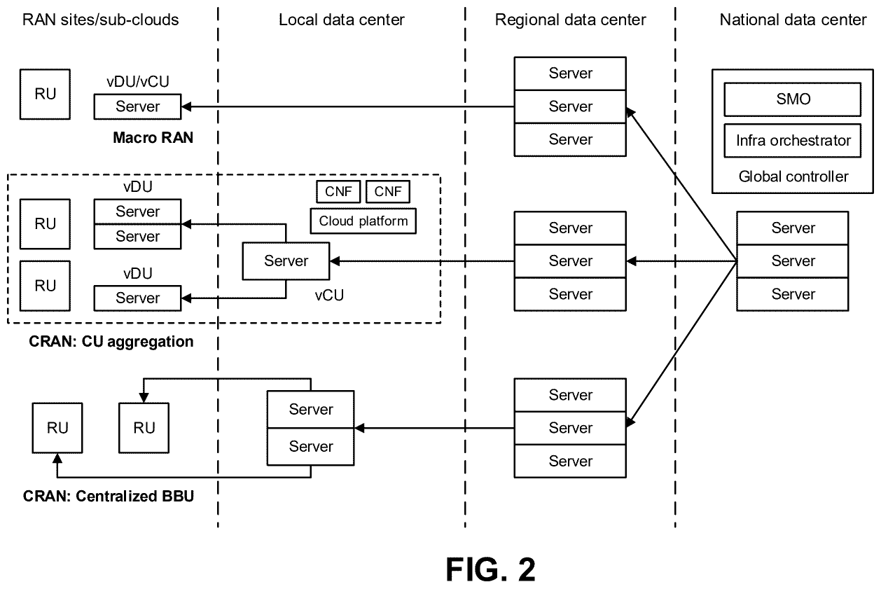

Turning next to FIG. 2, an example communication network architecture on which various implementations described herein can function is illustrated. The network topology shown in FIG. 2 is an example of a 5G deployment, which is constructed of clusters with various platforms and servers as described below. The deployment utilizes a hierarchical topology, with a national data center, regional data centers, local data centers, and RAN sites (sub-clouds) that provide different levels of functionality. For instance, the national data center can include base software components to manage and bring up 5G system controllers and sub-clouds. The national data center can also maintain a global controller for the network, which can facilitate functionality such as Service Management and Orchestration (SMO), infrastructure orchestration, and/or other functionality. The regional data centers can include system controllers and associated components, such as analytics or the like, along with distributed storage to run 5G workload applications. The local data centers can contain Open RAN (O-RAN) components such as an O-RAN centralized unit (CU) to run gNB applications. The RAN sites and/or sub-clouds can include servers that are placed in proximity of the cell site antennas in which the gNB distributed unit (DU) applications are deployed. As further shown in FIG. 2, the cell site antennas can be associated with one or more radio units (RUs). The server blocks shown in FIG. 2 represent server clusters, e.g., Kubernetes clusters or the like, which can provide a virtualized environment to run containerized applications.

As additionally shown in FIG. 2, a variety of local implementations can be present within a single network topology and its respective hierarchical layers. For instance, the top portion of FIG. 2 illustrates a macro RAN implementation in which the CU and DU are both implemented via a server at the cell site and communicate directly with a corresponding regional data center. The middle portion of FIG. 2 illustrates a centralized RAN (CRAN) with CU aggregation, in which a server of the local data center implements virtual CU (vCU) functionality via cloud-native network functions (CNFs) of a cloud platform. The local data center server, in turn, is communicatively coupled to servers at sub-cloud sites that implement virtual DU (vDU) functionality. The bottom portion of FIG. 2 illustrates a centralized baseband unit (BBU) implementation, in which servers at a local data center provide data processing functionality for RUs at respective RAN sites associated with that data center. It is noted that the examples shown in FIG. 2 are intended as a non-exhaustive listing, and that other examples are also possible.

In a network environment such as that shown by FIG. 2, each of the clouds/clusters are interdependent, e.g., such that impacts to one cluster can have an avalanche effect on other clusters. Accordingly, it is desirable for information technology (IT) staff and/or other system administrators to consider the overall implications of a server firmware update to plan for the upgrade of the entire deployment. As noted above, each cluster server can be expected to run the same set of firmware images, e.g., to avoid performance and/or scalability impacts for the workload applications. However, a typical 5G deployment is very large, e.g., with thousands of sub-clouds per regional data center, and about 20 servers per sub-cloud. Additionally, each national data center can have multiple regional data centers, and each regional data center can in turn have hundreds of servers, each of which can have different specifications and/or associated hardware components. Considering the scale of the deployments and the number of servers involved, it can be a highly complex and error-prone task for administrators to plan for a firmware update in a deterministic fashion without impacting SLA.

With reference now to FIG. 3, an example FL framework that can be used, e.g., by system 100 as described above with respect to FIG. 1, to facilitate AI-based server firmware upgrades in telecommunication clusters is illustrated. The FL framework shown in FIG. 3 includes an AI-driven upgrade platform 310, which can schedule and execute firmware upgrades for corresponding telecommunications deployments 320 based on guidance received from a central firmware update controller 330, which can operate as described above with respect to system 100 of FIG. 1. The central firmware update controller 330 includes a global AI upgrade model, which can be trained via FL using anonymized data from local AI upgrade models of the participating telecommunications deployments 320. The central firmware update controller 330 also includes a secure per-tenant upgrade results database, which can store information relating to the results of firmware upgrades performed at respective telecommunications deployments 320, e.g., for auditing purposes.

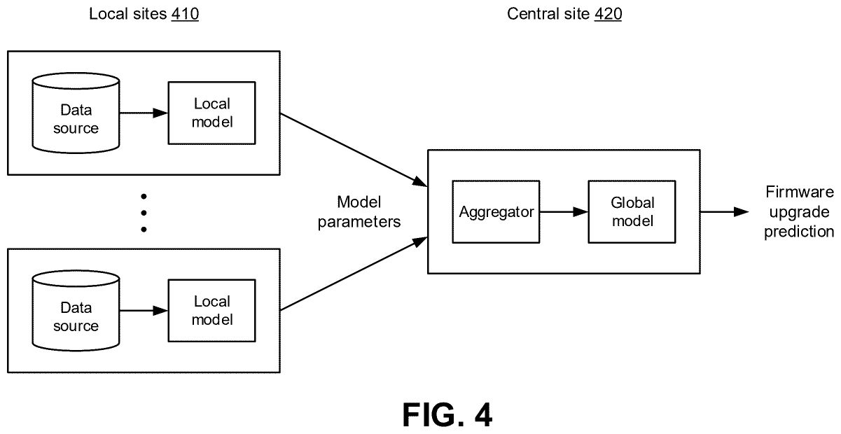

The AI-driven upgrade platform 310 shown in FIG. 3 can be a per-deployment platform, i.e., such that each telecommunications deployment 320 is associated with its own AI-driven upgrade platform 310. This can be done for data security purposes, e.g., to prevent internal data from being shared between different provider deployments. The AI-driven upgrade platform 310 includes a lifecycle management controller which can, given a firmware lineup, automatically schedule and execute firmware upgrades based on input from the global AI upgrade model of the central firmware update controller 330. For example, the global AI upgrade model can select a time of day for an upgrade based on a time associated with a lowest number of expected connected users. Additional factors that can be considered for a given firmware upgrade are described in further detail below with respect to FIGS. 4-6.

Additionally, the AI-driven upgrade platform 310 includes a local AI upgrade model that is trained using local upgrade results (e.g., results of firmware upgrades for the associated telecommunications deployment 320). The local AI upgrade model can participate in FL by sending model parameters to the aggregator of the central firmware update controller 330. To protect the security of user-or network-related information, the data provided to the aggregator by the local AI upgrade model can consist of anonymized data. For instance, the aggregator can receive model weights or other model parameter data from the local AI upgrade model without receiving any other data, such as user data, system data, or the like, from the local model.

Returning now to FIG. 1, system 100 can implement the framework described above with respect to FIG. 3 to generate update schedule data for a given telecommunications system 22 based on data collected from local ML models 30 of one or more telecommunications systems 20 and/or 22. For instance, provided a given firmware lineup, system 100 can use a global ML model 10 as described below to automatically determine (infer) the time window and/or procedural steps to perform the firmware upgrade without impacting active workloads, thereby maintaining SLAs associated with the telecommunications systems 20, 22.

Initially, the model refiner 110 can collect deployment data from respective sources associated with the telecommunications systems 20, 22 to facilitate processing by the global ML model 10. This data can include, e.g., server telemetry data representative of a performance of a server (e.g., a server associated with a telecommunications system 20, 22), server hardware configuration data representative of a hardware and/or software configuration of the server, network performance data representative of performance of network equipment of a network (e.g., a network associated with a telecommunications system 20, 22), network usage pattern data representative of a pattern associated with usage of the network equipment of the network, and/or other suitable types of data. Other types of data could also be collected.

In an implementation, the model refiner can collect runtime properties from servers associated with the telecommunications system 20, 22. These runtime properties can include, e.g., processor load, memory utilization, hard disk occupancy, virtual memory, temperature, alarms, and/or other runtime properties suitable to assess the current state of the servers in a given cluster. The model refiner 110 can provide this data to the global ML model 10, which can be trained to determine an optimal server upgrade schedule based on factors such as, e.g., server state based on historic data, the current server time zone, a minimum number of mobile users that will be impacted by an upgrade based on current data, and/or other factors. A resulting upgrade schedule for a given telecommunications system 22 can then be provided by the upgrade scheduler 120 to the telecommunications system 22 for further processing.

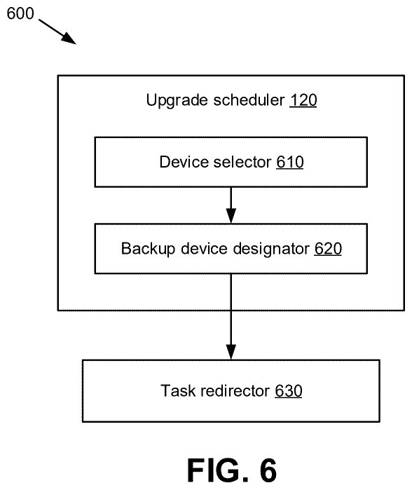

In implementations, an upgrade schedule generated by the upgrade scheduler 120 can include a list of servers of a given telecommunications system 22 that are ready to be upgraded. This list can be a priority list, e.g., that includes an order for upgrades that will result in the optimal upgrade process for the deployment as a whole. In addition, the upgrade schedule can include a list of backup servers to which application load can be migrated while upgrading respective servers or other devices. Selection of backup devices in this manner is described in further detail below with respect to FIGS. 6-9.

While not shown in FIG. 1 for simplicity, the model refiner 110 can receive additional model parameter data as a result of executing a firmware upgrade according to an upgrade schedule produced by the upgrade scheduler 120. Thus, for example, the model refiner could repeat parameter adjustment of the global ML model 10 based on additional model parameter data, e.g., model parameter data received from a local ML model 30 of the telecommunications system 22 (not shown in FIG. 1) based on a result of applying a scheduled firmware upgrade to at least one device of the telecommunications system 22.

Examples of model features (inputs) and model labels (outputs) that can be utilized by system 100 in various implementations are provided below. It is noted, however, that the following is a non-exhaustive listing and that other inputs and/or outputs are possible.

### Example Model Features (Inputs)

1) Characteristics of the servers to upgrade (CPU, memory usage, storage, etc.)

2) Characteristics of designated backup servers (CPU, memory usage, storage, etc.)

3) Server telemetry (CPU, memory, etc.) over time

4) Whether the server is associated with a cloud platform and/or an edge server

5) Network latency, reliability and bandwidth

6) Number of mobile users connected to a given RU/DU

7) Signal strength of a given base station (RU)

8) Number and location(s) of failure(s) in the system

9) Internal Kubernetes cluster status

10) Workload application type(s)

11) Results of upgrades-failed or succeeded, estimated duration of the upgrade vs. actual duration, logs and/or events which occurred during the upgrade, a snapshot of the system state before and after the upgrade (e.g., server CPU, memory, etc.), etc.

12) Upgrade constraints-total maximum duration of an upgrade per server and/or cluster, time window for upgrades (e.g., maximum duration, time of day or time range, etc.), physical deployment setup (in terms of available servers and/or clusters, physical network topology, etc.), etc.

Example model labels (outputs)

1) Optimal time of day to upgrade

2) Designated cluster(s) to upgrade

3) Which servers to upgrade, when to upgrade the servers, and in which order

4) Designated servers to use as backup/fallback

5) Estimate of the total duration of the upgrade

Turning to FIG. 4, an example FL framework that can be utilized by various implementations described herein is illustrated. As described above, FL is an ML approach that enables a model to be trained across decentralized local sites 410, e.g., telecommunications deployment edge servers, while keeping data localized and without exchanging raw user data with the central site 420. The local sites can run a smaller local model and update their model parameters based on local training. In some implementations, the local sites 410 can correspond to different telecommunications deployments, e.g., communication networks maintained by a communication provider. Alternatively, a given telecommunications provider may maintain multiple local sites 410, e.g., for the same network and/or different networks. Example steps of the FL process that can be conducted by the local sites 410 and the central site 420 are described below.

1) Initialization: Initially, a global model is created at the central site 420 with a comparatively high amount of allocated computing resources, e.g., in terms of power, processor cycles, etc., compared to the local sites 410. In an implementation, the global model can be initialized with random parameters to ensure that the initial model is unbiased and not influenced by any specific data distribution.

2) Device data collection: The local sites 410, e.g., corresponding to edge servers deployed at cell sites and/or other remote locations, can serve as data sources. Devices at one or more of the local sites 410 can be selected by the central site 420 to participate in the learning process. The selection of devices can be influenced by factors such as device availability, user consent, data quality, computational capabilities of the local devices, and/or other factors. By way of example, a device having a large dataset and substantial computational power can be designated by the central site as a preferred candidate.

3) Local training: Each selected device at the local sites 410 can perform local model training using its own data. This training can be done with local datasets, ensuring that sensitive data stays at the respective local sites 410. This local training can use various ML algorithms, including deep learning. In comparison to the global model of the central site 420, which can include a large number of parameters (e.g., on the order of millions of parameters), the local models at the local sites 410 can have a comparatively small number of parameters that are tailored to a particular deployment.

4) Model update: After local training, the local sites 410 can send model parameter updates, e.g., in the form of gradients, matrix weights, or the like, back to the aggregator of the central site 420. These updates can represent how the parameters of the global model can be adjusted to improve its performance based on the local data. While the aggregator can collect these updates from the selected local sites 410, it is important to note that the actual data on the servers of the local sites 410, which could include personal or sensitive information, does not leave the local sites 410. In addition, optimizations, e.g., to handle class imbalance and/or non-independent and identically distributed (IID) data across the local sites 410, can also be performed at the model update stage.

5) Aggregation: The aggregator of the central site 420 can aggregate the received updates from all participating local sites 410. One example of a technique that can be used for aggregation is federated averaging, in which the updates are averaged to create a new global model. Other aggregation methods, such as those to handle devices with varying levels of data quality and/or different trust levels, or to provide differential privacy guarantees during the aggregation process, can also be used.

6) Iteration: The FL process can be iterative, e.g., such that steps 3 to 5 above are repeated for a predefined number of rounds or until a convergence criterion is met. This can enable the global model to improve over time through collaboration with multiple local sites 410. The number of iterations and/or convergence criteria used for iteration can be determined during the testing phase.

Through the steps set out above, the global model maintained by the central site 420 can be refined, e.g., via adjustment of the parameters of the global model. In the event that a new model is to be deployed, e.g., to change the model from a first model type (e.g., a tree-based model) to a second model type (e.g., a neural network), the steps described above can be repeated for the new model type.

The use of FL as shown in FIG. 4 can provide various advantages over different types of ML algorithms. For instance, FL can protect user privacy by not moving any data out of the local sites 410 and only sending model parameters back to the central site 420. Additionally, because the raw data collected by the local sites 410 is never transported to the central site 420, communication efficiency can be increased because the raw metrics could amount to a large set of data. By sending the model updates instead of the raw data, only a small fraction of the data collected by the local sites 410 is sent, saving bandwidth and associated costs. As another advantage, FL is very suitable for dealing with servers of varying computational power and data quality, and can adapt to high-end servers as well as low-end servers. Other advantages are also possible.

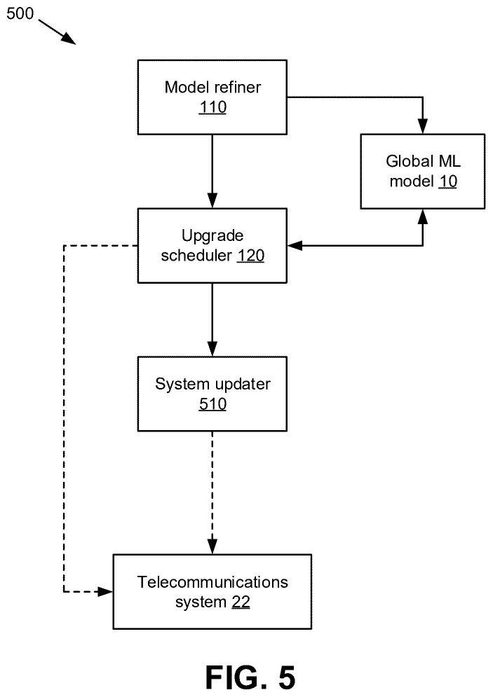

Turning now to FIG. 5, a block diagram of another system 500 that facilitates AI-based server firmware upgrades in telecommunication clusters is illustrated. Repetitive description of like parts described above with regard to other implementations is omitted for brevity. System 500 as shown in FIG. 5 includes a model refiner 110 and an upgrade scheduler 120 that can operate as described above, e.g., with respect to FIG. 1. For example, as described above, the upgrade scheduler 120 can generate a firmware upgrade schedule for a telecommunications system 22, which can include an ordered list of devices of the telecommunications system 22 to be upgraded during a firmware upgrade and a time window for application of the firmware upgrade.

In an implementation, the upgrade scheduler 120 can determine an upgrade schedule for the telecommunications system 22 using a global ML model 10, which can be trained as described above, e.g., with respect to FIGS. 3-4. For instance, once the global ML model 10 has been trained on a given set of training data, e.g., corresponding to different telecommunications deployments, the upgrade scheduler 120 can provide information pertaining to a target deployment, e.g., telecommunications system 22 as shown in FIG. 5, based on which the upgrade scheduler 120 can generate upgrade scheduling information. Information utilized by the upgrade scheduler 120 for this purpose can include, e.g., one or more of the model input data types described above, and/or other suitable types of data. In addition, the model refiner 110 can facilitate a continuous learning process for the global ML model 10, e.g., based on the results of firmware upgrades scheduled by the upgrade scheduler 120.

As further shown in FIG. 5, system 500 also includes a system updater 510 that can upgrade, during a time window specified by the upgrade scheduler 120 as described above, firmware associated with respective devices of the telecommunications system 22, e.g., in an order defined by the ordered list specified by the upgrade scheduler 120. In various implementations, the system updater 510 can be implemented globally, e.g., via the central firmware update controller 330 shown in FIG. 3, and/or locally at respective local system deployments. In a global implementation of the system updater 510, system 500 can be responsible for directly performing upgrade-related tasks at the telecommunications system 22, e.g., via the use of remote procedures or the like. Alternatively, in a more localized implementation, the system updater 510 can be used to present an upgrade schedule or plan to an administrator or other user responsible for the telecommunications system 22, which in turn can activate or approve execution of the schedule. Whether the system updater 510 operates locally or globally in this manner can be based on factors such as policies of the telecommunications system 22, agreements in place between the operator(s) of system 500 and the telecommunications system 22, network conditions between system 500 and the telecommunications system 22, and/or other factors.

In implementations, the upgrade scheduler 120 can, in addition to determining an ordered list of devices to upgrade for a given firmware upgrade process, determine backup devices to which workloads associated with devices to be upgraded are to be redirected during the upgrade process. For example, as shown by system 600 in FIG. 6, the upgrade scheduler 120 can include a device selector 610 that can determine an ordered list of devices to be upgraded, e.g., as described above with respect to FIG. 5, as well as a backup device designator 620 that can generate a list of backup devices of a given system (e.g., telecommunications system 22 as shown in FIG. 5) to which workloads associated with the target devices of an associated firmware upgrade are to be offloaded during the firmware upgrade. As further shown in system 600, the upgrade scheduler 120 can interact with a task redirector 630, which can redirect, during the time window associated with the upgrade, the workloads associated with the target devices of the upgrade to the corresponding designated backup devices.

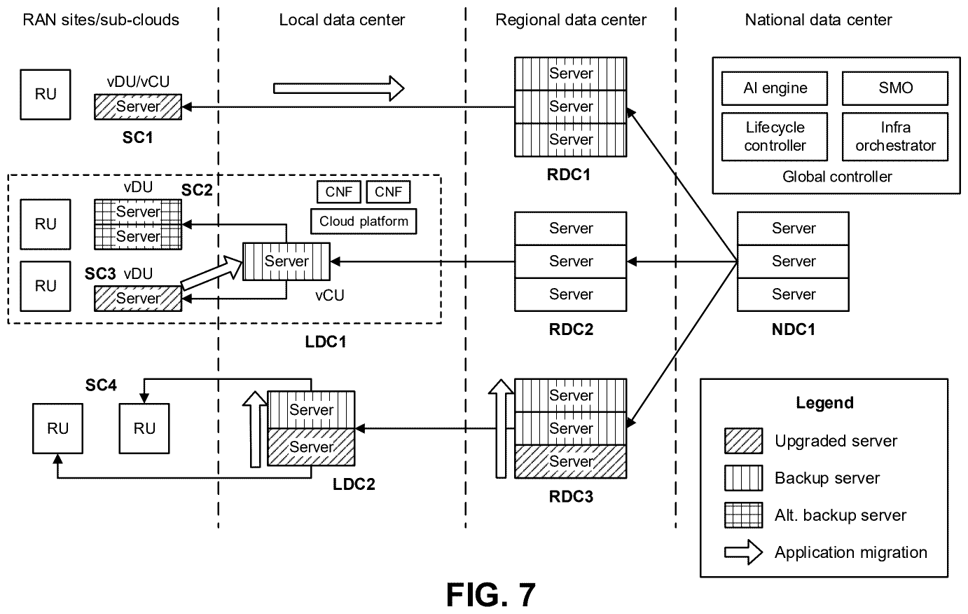

With reference still to FIG. 6, and with further reference to FIG. 5, the backup device designator 620 of the upgrade scheduler 120 can leverage the global ML model 10 to determine a backup server and/or cluster to which active workloads are to be migrated based on factors that can include, but are not limited to, the following. For example, the backup device designator 620 can select backup server(s) for a given target server from the servers in the network that neighbor the target server and exhibit acceptable degrees latency and/or throughput, e.g., based on current and/or historical performance data. The backup device designator 620 can also designate a backup server based on server state information and/or server characteristics (e.g., load levels, etc.), which can also be based on current and/or historical data. Additionally, in the case of a cluster with servers in a high availability (HA) configuration, such as a Kubernetes cluster, the backup device designator 620 can select, as a backup server, a standby server in the same cluster as the target server. Additional criteria and factors that can be utilized in selecting a backup server for a given target server are described in further detail below with respect to FIGS. 7-9.

Based on a generated upgrade schedule including designated backup servers, the upgrade scheduler 120 and/or system updater 510 shown in FIG. 5 can trigger an automatic update on the target servers while ensuring an associated SLA is maintained by draining the workloads from a given target server to the determined backup server(s). In the case of a failure, the upgrade scheduler 120 and/or system updater 510 can revert the firmware to a previous good version and restore the workloads to their pre-upgrade state.

Referring now to FIG. 7, an example upgrade schedule that can be generated for the network topology of FIG. 2 as described above is illustrated. The network topology shown in FIG. 7 represents a telecommunications deployment that utilizes a similar hierarchical structure to that shown by FIG. 2 above, e.g., with a national data center, regional data centers, local data centers, and RAN sites and/or sub-clouds. More particularly, the topology shown in FIG. 7 includes one national data center, denoted as NDC1, with three servers. Additionally, the global controller of NDC1 includes an AI-driven lifecycle controller, e.g., as described above with respect to FIG. 3. The lifecycle controller executes the firmware updates for the regional data center, local data center, and sub-cloud servers as described below. The backup servers, servers to upgrade, sequence of operations, time window, and/or other parameters of the upgrade can be selected by the AI engine of NDC1 based on conditions of the telecommunications deployment and its constraints, such as physical setup (e.g., connectivity, cluster configuration and location, etc.) and/or other parameters that are preconfigured at NDC1.

The regional data centers, denoted as RDC1, RDC2, and RDC3, each have a cluster of three servers. The firmware update is performed for one server at a time, with the other two servers used as backup (e.g., based on Kubernetes policies). For clarity of illustration, this process is illustrated in FIG. 7 for the upgrade of RDC3 only.

The local data center designated in FIG. 7 as LDC1 has a single server that is directly connected to RDC2. Accordingly, one or more servers of RDC2 can be selected as backup when the firmware update is performed on the server of LDC1. Additionally, the local data center designated in FIG. 7 as LDC2 has two servers, and as a result one server can be selected as backup for the other server during the firmware update.

Sub-cloud 1 (SC1) as shown in FIG. 7 has a single server that is directly connected to RDC1. Accordingly, a server of RDC1 can be selected as backup during the firmware update of the SC1 server. For sub-cloud 2 (SC2), an alternate server within the same cluster within the same cluster can be selected as backup during the firmware update. For sub-cloud 3 (SC3), a server in SC2, or the directly connected LDC1 server, could be selected as a backup server (e.g., based on the output of the AI engine of the lifecycle controller). In the latter case, LDC1 can be upgraded at a different time from SC3.

It is noted in the case of Kubernetes clusters (e.g., of three nodes or more), during a server upgrade, applications can be migrated to the backup servers as shown in FIG. 7 without any impact to the workload applications.

In an implementation, the backup designations shown in FIG. 7 can be selected in view of the relative compute power of the different illustrated hierarchical tiers. For instance, as the network approaches the edge (e.g., at the RAN site/sub-cloud level), the associated servers become smaller and less powerful, e.g., due to serving a smaller area, but are located physically nearer to network data applications. Thus, for instance, for upgrades of a server associated with a RAN site, more powerful but more distant servers, such as a server associated with a data center communicatively coupled to the RAN site, can be designated for backup. Similar considerations can be made for other network locations.

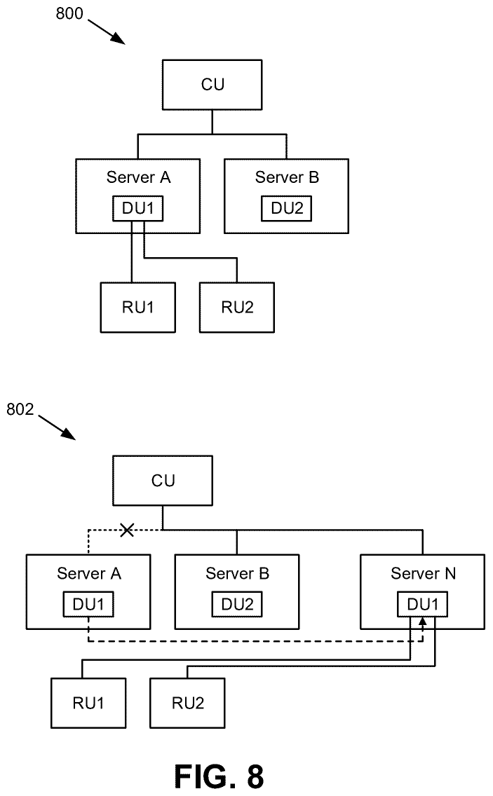

With reference now to FIG. 8, diagrams 800 and 802 illustrating example considerations for selecting a backup system for a standalone server are provided. More particularly, diagram 800 shows the state of a set of servers prior to a firmware upgrade, while diagram 802 shows the state of the same set of servers during the upgrade. In general, a backup system for a given server can be either another server or a cluster that satisfies various characteristics, such as having enough available processing power, memory, and/or other resources for the duration of the upgrade. These characteristics can be measured at the time the upgrade starts and/or a time immediately preceding the upgrade, e.g., as shown in diagram 800.

Additionally, a backup server for a given system can be determined by the AI engine described above for the estimated duration of the upgrade, based on parameters such as connection characteristics of the upgraded server with other applications (e.g., similarities as shown in diagram 802 between DU1 at Server N to DU1 of Server A, and/or between Servers A and N to RU1 and RU2, etc.), probability of failure (e.g., as inferred by the AI engine), or the like.

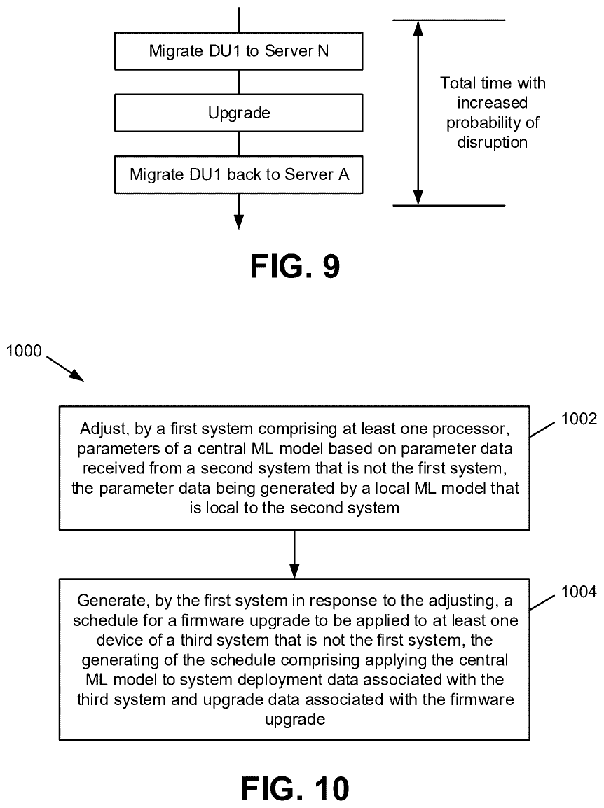

An example timeline associated with the backup designation and firmware upgrade processes of FIG. 8 is illustrated by FIG. 9. As shown by FIG. 9, the total time associated with migrating the workloads of DU1 to Server N, performing the upgrade at Server A, and then migrating the DU1 workloads back to Server A can be associated with an increased probability of service disruption. Accordingly, the AI engine can schedule and/or perform these tasks such that this time interval is reduced or minimized.

Various implementations as described above can facilitate AI-driven automatic firmware upgrade scheduling and execution for large-scale telecommunication deployments. For instance, based on an AI model, a lifecycle management controller as described herein can determine the optimum backup servers where software workloads from the upgraded servers can be migrated during the upgrade process, the optimum time window of the upgrades for individual servers and server clusters, and/or other scheduling items.

Additionally, various implementations described herein can further facilitate an AI-driven centralized “upgrade as a service” controller, with anonymized training input from multiple mobile telecommunication providers. This AI model can be continuously updated with new upgrade results from multiple sources, thereby avoiding model drift where a model trained on old data can no longer provide correct output.

Further, various implementations described herein can apply AI federated learning to train AI models for 5G telecommunication and/or similar firmware upgrades. Upgrade results from multiple deployments can also be used to train a global AI model.

Turning to FIG. 10, a flow diagram of a method 1000 that facilitates AI-based server firmware upgrades in telecommunication clusters is illustrated. At 1002, a first system comprising at least one processor can adjust (e.g., by a model refiner 110) parameters of a central ML model (e.g., a global ML model 10) based on parameter data received by a second system (e.g., a telecommunications system 20) that is not the first system. The parameter data can be generated by a local ML model (e.g., a local ML model 30) that is local to the second system.

At 1004, in response to the adjusting performed at 1002, the first system can generate (e.g., by an upgrade scheduler 120) a schedule for a firmware upgrade to be applied to at least one device of a third system (e.g., a telecommunications system 22) that is note the first system. The generating of the schedule can include applying the central ML model to system deployment data associated with the third system and upgrade data associated with the firmware upgrade.

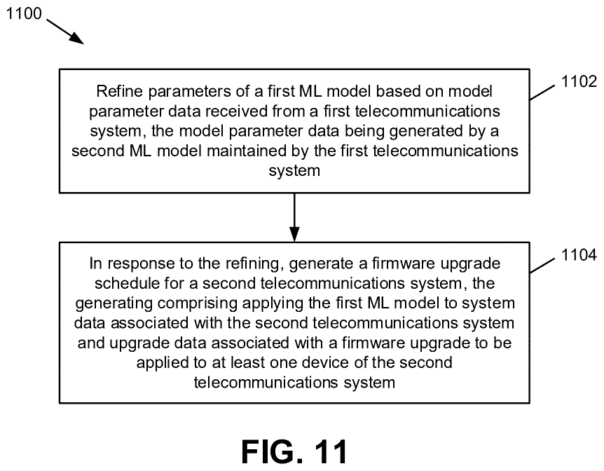

Referring next to FIG. 11, a flow diagram of a method 1100 that can be performed by at least one processor, e.g., based on machine-executable instructions stored on a non-transitory machine-readable medium, is illustrated. Example of computer architectures, including a processor and non-transitory media, that can be utilized to implement method 1000 are described below with respect to FIGS. 12-13.

Method 1100 can begin at 1102, in which the at least one processor can refine parameters of a first ML model based on model parameter data received from a first telecommunications system. The model parameter data can be generated by a second ML model maintained by the first telecommunications system.

At 1104, in response to the refining at 1102, the at least one processor can generate a firmware upgrade schedule for a second telecommunications system. Generation of the upgrade schedule at 1104 can include applying the first ML model to system data associated with the second telecommunications system and upgrade data associated with a firmware upgrade to be applied to at least on device of the second telecommunications system.

FIGS. 10-11 as described above illustrate methods in accordance with certain embodiments of this disclosure. While, for purposes of simplicity of explanation, the methods have been shown and described as series of acts, it is to be understood and appreciated that this disclosure is not limited by the order of acts, as some acts may occur in different orders and/or concurrently with other acts from that shown and described herein. For example, those skilled in the art will understand and appreciate that methods can alternatively be represented as a series of interrelated states or events, such as in a state diagram. Moreover, not all illustrated acts may be required to implement methods in accordance with certain embodiments of this disclosure.

In order to provide additional context for various embodiments described herein, FIGS. 12-13 and the following discussion are intended to provide a brief, general description of suitable computing environments 1200, 1300 in which the various embodiments of the embodiment described herein can be implemented. More particularly, FIG. 12 illustrates a general-purpose computing environment 1200 that can be utilized to implement some of the computer-executable components described above, while FIG. 13 illustrates a server computing environment 1300 on which deep learning models and/or other ML models as described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference now to FIG. 12, an example general-purpose environment 1200 for implementing various embodiments described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a non-volatile memory such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 (e.g., EIDE, SATA), one or more external storage devices 1216 (e.g., a magnetic floppy disk drive (FDD), a memory stick or flash drive reader, a memory card reader, etc.) and an optical disk drive 1220 (e.g., which can read or write from a CD-ROM disc, a DVD, a BD, etc.). While the internal HDD 1214 is illustrated as located within the computer 1202, the internal HDD 1214 can also be configured for external use in a suitable chassis (not shown). Additionally, while not shown in environment 1200, a solid state drive (SSD) could be used in addition to, or in place of, an HDD 1214. The HDD 1214, external storage device(s) 1216 and optical disk drive 1220 can be connected to the system bus 1208 by an HDD interface 1224, an external storage interface 1226 and an optical drive interface 1228, respectively. The interface 1224 for external drive implementations can include at least one or both o.

Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (VM) of multiple VMs hosted at computer 1202. Furthermore, operating system 1230 can provide runtime environments, such as the Java runtime environment or the NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1394 serial port, a game port, a USB port, an IR interface, a BLUETOOTH® interface, etc.

A monitor 1246 or other type of display device can be also connected to the system bus 1208 via an interface, such as a video adapter 1248. In addition to the monitor 1246, a computer typically includes other peripheral output devices (not shown), such as speakers, printers, etc.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the Internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are example and other means of establishing a communications link between the computers can be used.

When used in either a LAN or WAN networking environment, the computer 1202 can access cloud storage systems or other network-based storage systems in addition to, or in place of, external storage devices 1216 as described above. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Turning next to FIG. 13, an example server architecture 1300 that can be utilized in connection with one or more implementations described above is illustrated. The server architecture 1300 shown in FIG. 13 can be associated with a server device, such as a rackmount server, a blade server, or the like, which can be physically and/or communicatively coupled to a chassis (not shown in FIG. 13) and/or other physical devices for use in a computing environment such as a computing cloud, a data center, etc.

The server architecture 1300 shown in FIG. 13, referred to below as simply a server for brevity, can include one or more central processing units (CPUs), here two CPUs 1310, 1312. In a typical implementation of the server 1300, the CPUs 1310, 1312 are high-performance server processors that provide scalability and a high number of processing cores per CPU, e.g., up to 56 cores per processor for current implementations. The CPUs 1310, 1312 of the server 1300 are communicatively coupled to each other by, e.g., processor interconnect links, such as QuickPath Interconnect (QPI) or Ultra Path Interconnect (UPI) links developed by the Intel® Corporation. Alternatively, other means for coupling the CPUs 1310, 1312, such as a front side bus (FSB) or the like, could also be used. While two interconnect links are shown in FIG. 13 coupling CPUs 1310 and 1312, it is noted that more, or fewer, links could also be used.

The CPUs 1310, 1312 shown in FIG. 13 are additionally coupled to a system memory 1320, which can include one or more Dual In-line Memory Modules (DIMMs) and/or other devices. While the system memory 1320 is illustrated as a single block in FIG. 13 for simplicity, it is noted that the system memory 1320 is typically implemented via a group of memory modules. For example, the CPUs 1310, 1312 can collectively be associated with a number of DIMM slots (e.g., 16 slots, 32 slots, etc.), and DIMMs making up the system memory 1320 can be placed into these slots to facilitate connection to the CPUs 1310, 1312. Depending on implementation, the memory modules making up the system memory 1320 can be communicatively coupled to one, or more, of the CPUs 1310, 1312.

As further shown in FIG. 13, Peripheral Component Interconnect Express (PCIe) switches 1330, 1332 can connect the CPUs 1310, 1312 to respective other components of the server 1300, such as network interfaces 1340, 1342, storage controllers 1350, 1352, or the like. The network interfaces 1340, 1342 can include network interface cards (NICs) and/or other suitable components to facilitate connecting the server 1300 to other servers or suitable computing devices, e.g., in a clustered computing environment. The storage controllers 1350, 1352 can include nonvolatile memory express (NVMe) controllers and/or other interface devices that facilitate the coupling of storage devices, such as non-volatile RAM (NVRAM) devices, SSDs, or the like, to the server 1300.

While FIG. 13 shows a configuration in which each CPU 1310, 1312 is connected to one PCIe switch 1330, 1332, other configurations could be used. For instance, a one-to-many or many-to-one connection scheme could be used between the CPUs 1310, 1312 and the PCIe switches 1330, 1332. Similarly, the network interfaces 1340, 1342 and storage controllers 1350, 1352 could be connected to the PCIe switches 1330, 1332 in a one-to-many or many-to-one configuration in addition to, or in place of, the one-to-one connection scheme shown in FIG. 13.

The server 1300 shown in FIG. 13 further includes a group of co-processors, such as graphics processing units (GPUs), intelligence processing units (IPUs) for artificial intelligence workloads or the like. In FIG. 13, there are eight GPUs 1360-1367, which provide further processing capability to server 1300. While eight GPUs 1360-1367 are shown in FIG. 13, more, or fewer, GPUs could also be used. The GPUs 1360-1367 of server 1300 are preferably specialized GPUs that are designed for high-performance computing applications, such as H100 and/or A100 GPUs developed by the NVIDIA® Corporation, although other GPUs, IPUs, etc., could also be used. Each of the GPUs 1360-1367 of the server are communicatively coupled to each other via suitable communications links, such as NVLink® interconnects developed by the NVIDIA® Corporation and/or other suitable connections. In the example shown by FIG. 13, a GPU 1370 facilitates full interconnection between the GPUs 1360-1367. In other implementations, the GPUs 1360-1367 could instead be interconnected directly without the use of a switch or other means.

As additionally shown by FIG. 13, the GPU 1370 is communicatively coupled to the PCIe switches 1330, 1332 to enable communication between the GPUs 1360-1367 and other components of the server 1300. Other connection schemes could also be used. For instance, one or more of the GPUs 1360-1367 could connect to the PCIe switches 1330, 1332 and/or the CPUs 1310, 1312 directly, e.g., in an implementation in which a GPU 1370 is not present. In this architecture, deep learning models would be executed in the GPUs 1360-1367 rather than the CPUs 1310, 1312.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any embodiment or design described herein as “exemplary” and/or “demonstrative” is not necessarily to be construed as preferred or advantageous over other embodiments or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
at least one processor; and
at least one memory that stores executable instructions that, when executed by the at least one processor, facilitate performance of operations, the operations comprising:
adjusting parameters of a first machine learning model based on model parameter data representative of at least one model parameter usable to configure at least one model, the model parameter data having been received from a first telecommunications system deployment, and the model parameter data having been generated by a second machine learning model maintained by the first telecommunications system deployment; and
in response to the adjusting, generating a firmware upgrade schedule for a second telecommunications system deployment by applying the first machine learning model to deployment data associated with the second telecommunications system deployment and upgrade data associated with a firmware upgrade to be applied to at least one device of the second telecommunications system deployment.

2. The system of claim 1, wherein the firmware upgrade schedule comprises an ordered list of devices of the second telecommunications system deployment to be upgraded during the firmware upgrade and a time window for application of the firmware upgrade.

3. The system of claim 2, wherein the operations further comprise:
upgrading, during the time window, firmware associated with respective devices of the second telecommunications system deployment in an order defined by the ordered list.

4. The system of claim 2, wherein the devices of the ordered list are target devices of the second telecommunications system deployment, and wherein the firmware upgrade schedule further comprises a list of respective backup devices of the second telecommunications system deployment to which workloads associated with respective corresponding ones of the target devices are to be offloaded during the firmware upgrade.

5. The system of claim 4, wherein the operations further comprise:
redirecting, during the time window, the workloads associated with the target devices of the second telecommunications system deployment to respective ones of the backup devices that correspond to the target devices.

6. The system of claim 4, wherein the operations further comprise:
selecting, as a backup device of the backup devices corresponding to a target device of the target devices, a computing device located within a same cluster as the target device.

7. The system of claim 4, wherein a target device of the target devices is associated with a radio access network site, and wherein the operations further comprise:
selecting, as a backup device of the backup devices corresponding to the target device, a computing device associated with a data center communicatively coupled to the radio access network site.

8. The system of claim 1, wherein the deployment data is of at least one data type selected from a group of data types comprising a server telemetry type corresponding to server telemetry data representative of performance of a server, a server hardware type corresponding to server hardware configuration data representative of a hardware configuration of the server, a network performance type corresponding to network performance data representative of performance of network equipment of a network, and a network usage pattern type corresponding to network usage pattern data representative of a pattern associated with usage of the network equipment of the network.

9. The system of claim 1, wherein the model parameter data is first model parameter data, and wherein the operations further comprise:
repeating the adjusting of the parameters of the first machine learning model based on second model parameter data generated by a third machine learning model maintained by the second telecommunications system deployment, the second model parameter data being generated by the third machine learning model based on a result of applying the firmware upgrade to the at least one device of the second telecommunications system deployment.

10. The system of claim 1, wherein the operations further comprise:
receiving the model parameter data from the first telecommunications system deployment without receiving any other data, other than the model parameter data, from the first telecommunications system deployment.

11. A method, comprising:
adjusting, by a first system comprising at least one processor, parameters of a central machine learning model based on parameter data received from a second system that is not the first system, the parameter data being generated by a local machine learning model that is local to the second system; and
in response to the adjusting, generating, by the first system, a schedule for a firmware upgrade to be applied to at least one device of a third system that is not the first system, the generating of the schedule comprising applying the central machine learning model to system deployment data associated with the third system and upgrade data associated with the firmware upgrade.

12. The method of claim 11, wherein the schedule comprises an ordered list of devices of the third system to be upgraded during the firmware upgrade and a time window for applying the firmware upgrade.

13. The method of claim 12, further comprising:
upgrading, by the first system during the time window, firmware associated with respective devices of the third system in an order defined by the ordered list.

14. The method of claim 12, wherein the devices of the third system to be upgraded during the firmware upgrade are first devices, and wherein the schedule further designates respective second devices of the third system to which computing tasks associated with respective corresponding ones of the first devices are to be offloaded during the firmware upgrade.

15. The method of claim 14, further comprising:
redirecting, by the first system during the time window, the computing tasks associated with respective ones of the first devices of the third system to the respective second devices of the third system.

16. A non-transitory machine-readable medium comprising computer executable instructions that, when executed by at least one processor, facilitate performance of operations, the operations comprising:
refining parameters of a first machine learning model based on model parameter data received from a first telecommunications system, the model parameter data being generated by a second machine learning model maintained by the first telecommunications system; and
in response to the refining, generating a firmware upgrade schedule for a second telecommunications system, the generating comprising applying the first machine learning model to system data associated with the second telecommunications system and upgrade data associated with a firmware upgrade to be applied to at least one device of the second telecommunications system.

17. The non-transitory machine-readable medium of claim 16, wherein the firmware upgrade schedule comprises an ordered list of devices of the second telecommunications system to be upgraded during the firmware upgrade and a time window in which the firmware upgrade is to be applied.

18. The non-transitory machine-readable medium of claim 17, wherein the operations further comprise:
upgrading, during the time window, firmware associated with respective devices of the second telecommunications system in an order defined by the ordered list.

19. The non-transitory machine-readable medium of claim 17, wherein the devices of the ordered list are target devices of the second telecommunications system, and wherein the firmware upgrade schedule further comprises a list of respective backup devices of the second telecommunications system to which computing tasks assigned to respective corresponding ones of the target devices are to be offloaded during the firmware upgrade.

20. The non-transitory machine-readable medium of claim 19, wherein the operations further comprise:
redirecting, during the time window, the computing tasks assigned to the target devices of the second telecommunications system to respective ones of the backup devices that correspond to the target devices.
